(19) United States
(12) Patent Application Publication
(10) Pub. No.: US 2018/0066123 A1
(43) Pub. Date: Mar. 8, 2018

(54) LITTER ABATEMENT WITH A PHOTODEGRADABLE, SINGLE-USE, FOAMED POLYSTYRENE PACKAGING AND CONTAINER MATERIAL AND METHODS OF MAKING THE SAME

(71) Applicant: Lawrence W. MASTEN, Largo, FL (US)

(72) Inventor: Lawrence W. MASTEN, Largo, FL (US)

(21) Appl. No.: 15/807,192

(22) Filed: Nov. 8, 2017

Related U.S. Application Data
(63) Continuation of application No. 14/600,489, filed on Jan. 20, 2015.
(60) Provisional application No. 61/930,532, filed on Jan. 23, 2014.

(51) Int. Cl. C08J 9/18; C08J 9/14; C08J 9/00; C08J 9/232; B29K 105/00; B29K 25/00; B29K 105/04

(52) U.S. Cl. CPC C08J 9/18; C08J 9/141; C08J 9/0023; C08J 9/232; C08J 2203/14; C08J 2201/03; B29K 2105/0005; B29K 2025/06; C08J 2325/06; B29K 2995/0059; B29K 2105/04; C08J 2207/00; C08J 2300/16; B29K 2105/0017

(57) ABSTRACT

Food and beverage containers and non-food contact packaging “peanuts” are made of foamed polystyrene (PS) containing 0.5% to 15% by weight of the photoaccelerant, such as for example benzophenone. This additive greatly accelerates the photodegradation of this novel packaging for a specialized use: the abatement of litter comprising single-serving containers and packaging “peanuts” disposed of on land and in water. Conditions controlling the distribution of the photoaccelerant in and the formation of the polystyrene foam are critical to the rate of the photodegradation of this packaging in the environment.

### BACKGROUND OF THE INVENTION

Disposable single-use packaging has gained great favor with the advent of fast food restaurants and with increased numbers of meals served at various institutions such as schools and hospitals. However, litter generated from this packaging has remained an unsightly and undesired byproduct of fast food packaging. Currently, all types of food packaging including foamed polystyrene, paper and plastic/paper composites are known to persist as litter for years and represent a significant portion of litter found in the environment. Also packaging “peanuts” constituted a significant number of littered pieces found at beaches in much of the U.S. (Center for Marine Conservation, 1999).

To minimize the litter problem, different approaches to producing a photodegradable packaging, which degrades after exposure to sunlight and the elements, have been described elsewhere in broad terms (U.S. Pat. No. 3,832,312 to Wright, 1974; U.S. Pat. No. 4,495,315 to Miyoshi '315, 1985, and U.S. Pat. No. 4,517,318 to Miyoshi '318, 1985). However, details on the use of the safest and most effective photoaccelerant to obtain litter abatement have not previously been described, based on both environmental and human health considerations.

### BRIEF DESCRIPTION OF THE INVENTION

Food and beverage containers and non-food contact packaging “peanuts” are made of foamed polystyrene (PS) containing 0.5% to 15% by weight of the photoaccelerant, such as for example benzophenone. This additive greatly accelerates the photodegradation of this novel packaging for a specialized use: the abatement of litter comprising single-serving containers and packaging “peanuts” disposed of on land and in water. Conditions controlling the distribution of the photoaccelerant in and the formation of the polystyrene foam are critical to the rate of the photodegradation of this packaging in the environment.

### DETAILED DESCRIPTION OF THE INVENTION

The following represents claims for a novel food and beverage packaging system that has been demonstrated to control litter from single-serving containers and packaging peanuts found on land and in water where they can be exposed to sunlight.

Embodiments of the invention include a process for producing expandable polystyrene beads which, in turn, are used to manufacture foamed polystyrene packaging that photodegrades rapidly in the environment. This novel feature represents a means to control litter generated from the single use of food and beverage packaging as well as from non-food contact packaging made from this material.

The process to produce expandable beads for foam comprises impregnating polystyrene beads under heat (ca. 80° to 150° C.) and pressure (maximum pressure, 125 psig) with about 0.5 to 15 parts of a photoaccelerant, benzophenone, diphenyl-methanone (CAS No. 119-61-9) per 100 parts of foamed polystyrene by weight. Increasing the reactor temperature increases the rate of impregnation of both the photoaccelerant and the blowing agent. The photodegradable packaging is molded into shapes such as cups, containers, etc., from the foam expanding process with steam and heat on expandable polystyrene beads.

Photodegradable Expandable Polystyrene (PEPS) beads are produced by the pressure impregnation of hydrocarbon blowing agents such as pentane, isopentane and cyclopentane into uniformly-sized polystyrene beads. The beads are classified into various sizes by a vibrating screen system with “A” being the largest and “T” the smallest.

Pre-screened uniform polystyrene beads are introduced batchwise into an impregnation reactor which is, agitated and jacketed. Into this pressure vessel is added water, surfactants, suspending agents and additives. The reactor is taken through a preprogrammed time/temperature cycle and the blowing agent is added containing the photoaccelerant at a given temperature over a specified period of time, impregnating the voids in the polystyrene beads with liquid hydrocarbons and the photoaccelerant. The suspending agents and surfactants are used to suspend the solid polystyrene beads in an aqueous media. Various types of additives are used to impart particular physical properties for end-use applications. The maximum reactor temperature and pressure encountered during a typical impregnation cycle are 105° C. and 125 psig, respectively with about 0.5 to 15 parts of a photoaccelerant, benzophenone, diphenyl-methanone (CAS No. 119-61-9) per 100 parts of foamed polystyrene by weight. Increasing the reactor temperature increases the rate of impregnation of both the photoaccelerant and the blowing agent.

Once impregnation is completed, the contents of the reactor are transferred to the wash kettle where hydrochloric acid is added to dissolve the suspending agents. The PEP bead/water slurry is then pumped to the centrifuge where the water is separated into a fluidized bed dryer. Temperature and humidity of the fluidizing air must be controlled to reduce water content of the beads while maintaining the blowing agent content.

Dried PEPS beads are passed once more through a vibrating clean up screen to ensure the material meets final size classification specifications. Oversize and undersize beads are transferred to off grade while the prime beads flow to a continuous additive blender for final addition of lubricants and/or other surface additives. From the blender, the PEPS beads are packaged in either 250-pound drums or 1,000-pound cartons, each of which contains 2-mil laminated vapor barrier liners.

High molecular weight polystyrene beads comprising uniformly small diameter (e.g., ca. 0.0 1 in. to 0.02 in. for hot cups and containers with a minimum wall thickness of approximately 0.046 in., ca. 0.014 in. to 0.03 in. for thicker walled cups and containers with minimum thickness ca 0.90 in., and ca. 0.03 in. to 0.08 in. for the thickest walled cups and containers) are impregnated under heat and pressure to contain 3% to 20% by weight of a blowing agent such as pentane, isopentane, cyclopentane, or some mixture of any or all of these solvents. The use of the defined blowing agent ensures the reproducible production of PS foam with uniform cells or voids within the foam matrix.

The beads are impregnated under heat and pressure to contain 0.5% to 15% by weight of the photoaccelerant, benzophenone, uniformly distributed via the use of the blowing agent as described above. The use of the blowing agent to be co-impregnated with the photoaccelerant is important to ensure its uniform distribution within the PS matrix, prior to the steam induced foaming process.

Alternatively, a second process can be employed to produce photodegradable polystyrene foam food and beverage packaging as well as packaging “peanuts.” Expandable polystyrene beads impregnated with pentane or similar blowing agent and photoaccelerant from the process described above in this embodiment are fed into a heated extruder and melted to produce foamed sheet polystyrene containing a uniform distribution of the photoaccelerant. The use of an extruder with expandable PS beads has previously been described in U.S. Pat. No. 3,888,804 to Swanholm et al., 1975. However, in that patent, expandable polystyrene beads impregnated with pentane are melted in the extruder first. Then the photoaccelerant is added directly. This method is in contrast to this patent.

In the current process described herein, there is no need to add photoaccelerant directly and to monitor it in the extruder, since the expandable beads used already contain the proper level of photoaccelerant evenly distributed throughout the polystyrene matrix. Food packaging articles such as cups, bowls, clam shells, plates, trays, etc., are produced from the sheet foamed polystyrene containing photoaccelerant employing standard cutting and molding procedures for foamed polystyrene. Photoaccelerant- and blowing agent-containing beads or sheets comprising a mixture of 50% to 100% polystyrene and 0% to 50% by weight of another homopolymer such as polyethylene may be substituted for polystyrene beads in each of these two processes.

Benzophenone, the photoaccelerant is introduced into the polystyrene beads by dissolving it with or in a blowing agent that is co-impregnated into the polystyrene beads simultaneously with the photoaccelerant. Alternatively, the photoaccelerant and the blowing agent may be added separately, but essentially at the same time into a high pressure reactor producing expandable beads. In either impregnation process is facilitated with the use of anionic surfactants and a suspending agent such as tricalcium phosphate, for the polystyrene beads mixed with water. Suspending agents are added to the water in this system to keep the polystyrene beads from sticking together at the elevated temperatures used in this process. Under these conditions, a high efficiency of photoaccelerant impregnation can be obtained (90% to 99+ %) for benzophenone concentrations as great as 15% by weight of the packaging, based on mass balance data of the impregnation process.

The blowing agent content in these impregnated polystyrene beads is generally 3 to 20 parts per 100 parts of the impregnated beads prior to their “expanding”, “foaming” or “puffing.” Typical blowing agents used in this process include n-pentane, isopentane, cyclopentane as well as mixtures of the above and closely related solvents with respect to similar solubility, polarity, and volatility properties.

After water removal from the impregnated beads, they are “foamed” or “puffed” with steam (e.g., ca. 60 lbs/ft3), expelling the blowing agent to create expanded polystyrene beads which are first placed into a mold cavity and then heated (steamed) to fuse the beads into food and beverage containers. In the second option described herein, the foamed beads can be directly made into sheets, then cut and pressed into various food and beverage container shapes.

Cups and containers such as “clam shells,” bowls, platters and plates made of the new packaging have the same high insulation properties as those fabricated from traditional foamed polystyrene packaging. Hot foods and beverages are kept hot and cold foods and beverages remain cold for long periods of time in containers made of this new packaging material. This attribute is lacking with containers made of many other competing packaging materials such as paper and paper/plastic composites.

With a non-food contact use such as loosefill or packaging “peanuts,” this novel packaging material can be utilized, as manufactured, using one or more of the processes described above, with particular success controlling or eliminating litter from the use of this type of packaging instead of other types of non-food contact packaging. Loosefill packaging or packaging “peanuts” have been reported to constitute a major source of litter (Center for Marine Conservation, 1999) on land and found in waters of the U.S. If this novel packaging is accidentally released into the environment as loosefill or “peanuts,” it will quickly degrade yielding safe degradation products without any adverse environmental impact.

Loosefill is comprised of individual foam polystyrene pieces used to fill all of the empty spaces left when an article(s) is(are) placed into a box or carton for shipping. These pieces hold the article in place minimizing its movement while in transit and protect the article(s) from damage. These pieces are often referred to by such terms as “peanuts,” “foam peanuts,” or loosefill. Besides a peanut shape, these pieces may be produced in other shapes including spheres, blocks, “S” shapes, “C” shapes, “W” shapes and “8” shapes. Generally, the maximum length of these pieces is about 2 inches or less, depending on the respective shape and the maximum width of these pieces is less than 1 inch.

As described above, “peanuts” can be produced from pentane or a similar blowing agent and the photoaccelerant impregnated polystyrene beads above using either the puffing and molding process or the extruder and cutting/molding process. Colorants (such as carbon black, other pigments and organic dyes) can also be introduced in either process for producing “peanuts.” Pentane or a similar solvent can be utilized to dissolve a colorant when producing beads impregnated with the photoaccelerant. If an extruder is used, a colorant can be introduced into an extruder via direct mixing at the time when the photoaccelerant impregnated beads are melted, mixed, and extruded.

If “peanuts” are desired for use with electronic equipment, these foam polystyrene pieces can receive a secondary treatment such as a spray or dip to coat their surface with an antistatic agent designed to reduce or eliminate static electricity on the foam polystyrene pieces. Typically, agents such as long-chained quaternary ammonium compounds and mixtures containing these agents may be used for such a purpose.

Based on the environmental testing, it is essential to note that this new packaging is far superior to paper, conventional foamed polystyrene and other plastics, with or without additives, with respect to their degradation in the environment. These packaging materials are commonly found as litter in a variety of climates (Center for Marine Conservation, 1999) without any signs of degradation, even after many months of environmental exposure.

The processes described above can be optimized to obtain the maximum photodegradation rate from exposure to sunlight with minimal photoaccelerant concentrations. Besides the amount of photoaccelerant used, a number of other factors in these processes can be modified to obtain this optimization. This photodegradable polystyrene foam food and beverage packaging consists of a system which promotes the rapid photodegradation of the polystyrene foam when exposed to UV light:

(a) high molecular weight polystyrene, i.e., over 200,000 Daltons;

(b) foaming of polystyrene such that the spaces or cells are uniformly dispersed throughout this polystyrene matrix, each only separated by thin walls. This process results in a high internal surface area relative to outside surface area of the container or “peanut” packaging to transmit light energy on all sides from adjacent cells of uniform size. The use of efficient blowing agents such as the closely related pentane, isopentane and cyclopentane is required to affect the uniform location and size of the cells when the foam is formed with steam. The use of solvents which significantly differ in polarity and volatility will result in changes in the quality and quantity of the resulting foam with respect to its density and rate of photodegradation;

(c) uniform distribution of the photoaccelerant throughout all the wall of cells of the polystyrene foam matrix. The use of efficient blowing agents such as the closely related pentane, isopentane and cyclopentane is required to dissolve significant amounts of the photoaccelerant and to result in a high penetration rate (e.g., at least 90%) of the photoaccelerant, resulting in the uniform distribution of the photoaccelerant in this packaging. The use of solvents which significantly differ in polarity and volatility will result in less penetration and uneven photoaccelerant distribution, resulting in a slower rate of photodegradation.

The above features of polystyrene foam with a uniform photoaccelerant distribution allow for the efficient capture of ultraviolet (UV)-light energy to affect a rapid degradation of the polystyrene foam as well as the photoaccelerant, itself. The high ratio of internal surface area to the container mass and thin walls (to transmit UV-light) through the polystyrene foam together with the uniform distribution of the photoaccelerant are required for this series of photo-oxidation reactions. In turn, these reactions result in the photodegradation of this packaging. For this reason, the photodegradable polystyrene foam packaging is most precisely defined in terms of the process to first produce the starting material (i.e., expandable polystyrene beads) and process (steam induced foaming or “puffing”) rather than by the composition of the end product (i.e., the final packaging material).

A primary reason for the relative ease of this novel packaging to photodegrade is the result of the way it is manufactured. Hollow polystyrene “cells” or spaces formed from the expansion of polystyrene beads during the foaming process are generated which approximate a spherical shape, but are in fact thought to be deca-tetrahedrons (14-sided shapes) from electron micrographs of the packaging.

Based on experimental data, the average wall thickness of each cell wall is approximately 1.0 to 1.5 μm (microns) and 20 to 25 μm in diameter. Thus, assuming that each cell shape approximates a sphere, the average surface area of each cell is about 6.4×10³ μm². From these dimensions, the total estimated surface area in one gram of this packaging, produced as described above, is approximately 0.407 m². Then, as an example, the estimated surface area for an 8 oz. coffee cup made from this packaging weighing 3.25 g is 1.32 m². In contrast, if an 8 oz. cup were made of crystalline polystyrene, instead, with no internal surface area from the cells of the foam, the total surface area, inside and out, is only 0.045 m². Thus in this example, foaming increases the available surface area for photodegradation by over 29 times.

This difference in surface area, also characteristic of other shapes as well, is most likely a major reason that the surface-based photodegradation process occurs at a significantly greater rate with the foamed packaging via UV-light exposure and it is amplified with the benzophenone impregnation of this massive surface area. It also accounts for the reason used photodegradable cups, when melted in the recycling process, are not susceptible to rapid photodegradation in their new solid form.

The choice of uses for this packaging is critical to its performance with respect to containing food and beverages as well as to its use in litter abatement. One factor to be considered important for the use of this novel packaging material is the shape of the food or beverage container and the surface area of the respective container to its mass. Food and beverage items with a large surface area to mass include the following: coffee/tea cups, soda cups, bowls, platters, plates, “clam shells” as well as many other disposable, single serving containers. Packaging “peanuts” also fit well with this criterion.

Smaller containers, in addition to presenting a significant litter problem from fast food establishments, are by far the most likely to benefit from the litter abatement properties of this packaging material. For example, as just discussed, small size (8 oz.) coffee cups have a high ratio of surface area, inside and out, to their mass or weight. This property, in turn, affords the packaging the greatest opportunity to photodegrade. That is, the maximum amount of packaging material is exposed to sunlight (UV-light) to expedite the photodegradation process resulting in the breakdown of this material to non-toxic by-products within a relatively short time in the environment, as long as sunlight is available.

A second factor to be considered for the use of this packaging is its photoaccelerant concentration. Fast rates of photodegradation (about one to four months for the complete destruction of a coffee cup and less time for smaller items such as packaging “peanuts”) are obtained. However, the type of food or beverage to be contained in this packaging can limit the photoaccelerant concentration, depending on whether it is water (aqueous) or fat (lipid) based. Aqueous beverages such as coffee, tea, and soda can successfully be used with this packaging containing the higher concentrations of the photoaccelerant since it does not readily migrate from the packaging into those liquids due to its poor water solubility.

Based on blinded taste testing, foods and beverages, containing appreciable amounts of fat such as fried foods and certain soups, can only be used with foamed polystyrene packaging containing lower concentrations of this photoaccelerant. It migrates into these food items at levels that can be detected (tasted) by many people. For this reason, a version of this new packaging has been formulated especially for fatty foods to retain the photodegradability property while avoiding this taste problem.

The photoaccelerant at levels contained in foamed polystyrene is safe for use in packaging with both water-based and fatty foods and beverages. Since the photoaccelerant is already an approved flavor in the United States for use in a number of foods (21 C.F.R. § 172.515(b)), it is known that most people can discern concentrations of it approaching 1 ppm in a food or beverage product. While this taste experience is desirable in foods and beverages when intentionally added, it is considered an off-flavor that is unacceptable for food and beverage packaging uses. The new formulations of photoaccelerant in foamed polystyrene avoid this potential problem for both types of food and beverage containers when used with water- and fat-based foods and beverages, respectively. Note that taste issues are not relevant to the use of this photoaccelerant in packaging “peanuts.” Thus, a high concentration can be permitted or that non-food contact use with superior photodegradation results.

The use of blowing agents mentioned in the above-described processes to disperse uniformly the photoaccelerant, benzophenone, throughout the foamed polystyrene is essential to the rapid photodegradation of this packaging. The use of blowing agents to distribute the photoaccelerant evenly throughout the polymer matrix of the foamed polystyrene is in contrast to that found in earlier patents (Miyoshi '315 and Miyoshi '318), where the photoaccelerant was added to styrene monomer, then it was polymerized to polystyrene followed by the impregnation of the polymer with propane for foaming.

The use of volatile liquid blowing agents such as the alkanes, pentane, isopentane, cyclopentane, and chemicals with similar physical and chemical properties has a number of advantages. Each is generally easier to handle as a liquid and is more effective as the photoaccelerant carrier in the impregnation process than gases such as propane, even when liquefied under pressure. Additionally, the introduction of the photoaccelerant after the polymerization of styrene ensures that the benzophenone is more evenly distributed into the polystyrene foam walls and that it is chemically available in a free form, shown to accelerate the photodegradation of this polymer (Torikai et al., 1983). Thus, the photodegradation process is more uniform in its distribution within the foamed polystyrene.

The photoaccelerant used can also be introduced into other polystyrene foam processes via a blowing agent even in processes not utilizing polystyrene beads. This includes the direct foaming of polystyrene sheets, followed by molding or pressing into food and beverage packaging container shapes as well as packaging “peanuts.”

It is important to note that the process to produce packaging material with the photoaccelerant is completely compatible with that currently used for standard foamed polystyrene to produce food and beverage containers, and packaging “peanuts.” No special changes in the manufacturing process are required. This modified process is very similar to the one previously described (Wright, 1974). No retrofitting or special training is necessary to adapt current manufacturing technology to produce the new photodegradable packaging.

A method of photodegrading food and beverage containers and packaging “peanuts” made of foamed polystyrene impregnated with about 0.5 to 15 parts of benzophenone per 100 parts foamed polystyrene is described herein. The process for production of this packaging is as described above. This photodegradation method comprises the said foamed polystyrene packaging articles impregnated with benzophenone that are exposed to sunlight and may come into contact with a body of water or repeated rain storms.

The above methods are based on the results of environmental field studies. Basically, they consisted of two exposure types on land: inverted 8 oz. coffee cups are setting on wooden pegs on a board maintained outside at a 45° angle to the ground. For “peanuts,” the individual pieces were held on a flat surface, not allowed to blow around, e.g., using a fine wire mesh cage. In water, cups were contained in “chicken wire” cages and floated with buoys. A fine wire mesh cage was used for floating packaging “peanuts” in water with buoys. The predominate climatic conditions for these field exposures on land were warm and wet (Southeast U.S.), colder and wet (Northeast U.S.) or warm and dry (Southwest U.S.), but each has similar sunlight exposures.

At monthly intervals, cups and “peanuts” were removed from these exposure studies, carefully cleaned up as necessary, and weighed or counted as a measure of degradation. Additionally, the cups were characterized chemically to determine chemical entities including the photoaccelerant, and degradation products of polystyrene and the photoaccelerant.

Photodegradable coffee cups were found to degrade at a substantially faster rate while floating in water than on land, under the same climatic conditions. This result demonstrates that small containers such as coffee cups made of this packaging material will degrade at a fast rate if discharged at sea or fall into some other body of water. Also packaging “peanuts” degrade at a faster rate in water than on land. In turn, the photodegradation of this packaging in water makes it ideal for use on cruise ships and similar vessels that routinely discharge wastes while at sea. Additionally, the use of this photodegradable packaging is ideally suited for sale, for example, in and around National and State Parks and Forests, etc., where if littered in remote bodies of water or other remote areas, retrieval via litter patrols is not possible or not feasible due to cost.

For this novel packaging produced per the processes described above, non-toxic materials from photodegradation are benzoic acid and small molecular weight polymers of polystyrene from this foamed polystyrene and the photoaccelerant, benzophenone, contained in the packaging.

The photodegradability of this new packaging has been demonstrated by allowing the food and beverage containers containing the photoaccelerant to be exposed to sunlight (ultraviolet light), wind and rain, while on land or sunlight and wave action/currents while floating in water. The result is the accelerated degradation of this packaging material into non-toxic materials without adverse environmental impact to animal or plant life.

Degradation of foamed polystyrene containers containing the photoaccelerant also causes their rapid loss of elasticity and tensile strength (c.f., foamed polystyrene containers without photoaccelerant), fracturing into smaller and smaller pieces which may ultimately biodegrade to carbon dioxide and water. Also, there is a dramatic loss of mass. This characteristic decomposition pattern, with its loss of tensile strength, may greatly minimize any physical hazard potential of this packaging to various birds, land animals and fish as compared to conventional foamed polystyrene containers. The new packaging is much less likely to be trapped in the beaks or mouths of terrestrial and aquatic wildlife. With very little pressure, this material fractures into smaller and smaller, non-toxic pieces.

It is important to note that as this new packaging material photodegrades, associated with physical changes; it turns from a white to a tan color on land. A fine tan dust can be observed on the surface of cups undergoing weathering consisting of primarily degraded polystyrene and minimal degraded benzophenone. Since UV light found in sunlight is essential for photodegradation to occur, the rate of degradation of this litter is proportional to the length of exposure and intensity of sunlight to which it is exposed.

A thorough study of the photodegradation process has been reported with thin films of standard polystyrene and the photoaccelerant, benzophenone, but not with foamed polystyrene containing this photoaccelerant (Torikai et al., 1983). Presumably, these laboratory results on thin films of polystyrene are also explanatory for foamed polystyrene items with the same photoaccelerant containing very thin cell walls with large surface areas as discussed earlier. In water, no such dust is observed, probably due to the wave action removing as it is formed after light exposure.

The result of photodegradation of this packaging is the generation of non-toxic products, primarily smaller molecular weight polystyrene polymers, and benzoic acid. In the concentrations found, these degradation products are not environmental hazards to plant or animal life (Kaplan et al., 1979; Juhnke and Ludemann, 1978; Sax, 1989).

Non-toxic materials, carbon dioxide and water, can be formed from the biodegradation of substances generated from the photodegradation of this foamed polystyrene and benzophenone containing packaging as produced per claim 1. Benzophenone and benzoic acid, a major chemical degradation product of polystyrene, are known to biodegrade via water-borne and soil-borne organisms, ultimately to carbon dioxide and water (Banerjee et al., 1984; Rubin et al, 1982; Subba-Rao and Alexander, 1982; Kassim, 1982; Haider et al., 1974).

In a method of photodegrading, said body of water is an ocean, like rivers, stream, pond or the like that comes in contact with this packaging in the environment. Additionally, rain and wind can accelerate the photodegradation on both land and in water. Natural forces, which help remove the degraded polystyrene layer on the light exposed surfaces, enable additional UV (sunlight) exposure to accelerate the photodegradation of this new packaging. Climatic conditions are associated with faster rates of photodegradation of this packaging material. These forces include wave-action, currents and tides in oceans, lakes, and ponds, as well as wind and rain found with all of these bodies of water. For weathering on land, they include repeated wind and rain which remove the layer of degraded polystyrene from the cups and expose the surface area to more UV light.

For the method in which non-toxic materials can be formed, the packaging articles are food or beverage containers such as a drinking cup for hot or cold liquids, a bowl, a platter, a plate, a “clam shell,” or similar container. Also the non-food contact use of loosefill or packaging “peanuts” is included.

Following the method above in which beverage and food containers and packaging “peanuts” biodegrade, wherein during the photodegradation of litter made from this packaging material, its appearance is substantially more aesthetically pleasing than the typical litter from single use containers or packaging “peanuts.” Whether on land or in water, as an initial result of this process, container printing and coloration quickly are lost within a few days due to the photo-oxidation process induced by the photoaccelerant. In water, containers tend to favor the growth of fungi (e.g., Rhyzopus sp.), shellfish and other aquatic life. Thus, the appearance of this packaging blends into the environment more than conventional food packaging. On land, the exposed surfaces rapidly are covered with a light tan colored dust consisting of degraded polystyrene and degraded photoaccelerant. This coloration phenomenon camouflages the degrading packaging until it only exists in small pieces that disperse with the wind and rain, only to further photodegrade, ultimately biodegrade and disappear.

The packaging articles, e.g., cups, plates, bowl, etc., can be mixed with other sources of polystyrene and recycled to produce new, non-food and food contact articles. Items made of this new packaging, like foamed polystyrene, can be recycled with other sources of polystyrene. When mixed with other polystyrene, this packaging can comprise up to approximately 50% of the total to produce items such as picnic tables, lawn furniture and trash cans.

Also with special procedures to remove any foreign matter such as food, it is possible to regenerate polystyrene for food contact packaging. There are no significant differences in strength and durability in these products derived from recycling compared to items only from polystyrene without the photoaccelerant. Thus, this new packaging material does not have to be segregated from other sources of recycled polystyrene. No detectable lessening of the strength or general quality of this recycled packaging material was found. This recycled packaging material was not susceptible to increased photodegradation either, during the recycling process, lessening its expense, and allowing claims of recycling for this packaging a very positive attribute.

For packaging produced per the processes described above, the articles can be incinerated in modern, well-maintained municipal incinerators, generating high levels of energy per pound of used packaging without any significant change in the low output of volatiles or trace ash when compared to conventional foamed polystyrene packaging.

In properly run municipal incinerators, designed to generate energy from waste, the combustion of all sources of polystyrene results in the formation of primarily carbon dioxide, water vapor and trace levels of ash. Additionally, this incineration results in the efficient generation of large amounts of heat energy (16,000 BTU/lb. of plastic) which is approximately twice the energy content of coal (Magee, 1989). The inclusion of benzophenone up to 15% by weight into this new packaging material will not alter the incineration profile of foamed polystyrene at all. Benzophenone, itself, is completely combustible. Since this additive only contains carbon, oxygen and hydrogen atoms, benzophenone will burn cleanly with the foamed polystyrene to produce safe emissions of carbon dioxide and water plus heat energy. Thus, like conventional foamed polystyrene, this packaging material is a clean source of heat energy when it is incinerated as waste.

### EXAMPLE

Sufficient quantities of 8 oz. coffee cups were produced to conduct a series of preliminary weathering field studies with this new packaging containing approximately 2% by weight of the photoaccelerant (i.e., 2 wt %), benzophenone. These studies were conducted for 11 months to two years.

Various sites were chosen to simulate climatic conditions in the U.S. including one each in the Southwest (hot and dry), the Southeast (hot and wet) and the Northeast (cool and wet). In all three sites, the cups were weathered on land: cups at the two southern sites were inverted and mounted at a 45° angle on wooden pegs. At regular intervals, these cups were weighed, as a measure of photodegradation. This parameter was considered to be the most sensitive to detect photodegradation of these containers as the walls of these containers became thinner with time, before fracturing into many pieces.

Cups exposed at the Northeastern site were placed in wire cages and were free to move with the wind and rain. In this study, for simplicity, only the disappearance of complete cups was noted. Additionally, at the Southeastern site, cups were placed in wire cages and floated via polystyrene floats. These wire cages floated in salt water, subject to the effects of wave action, tides, and water currents. As in the above study, only the disappearance of cups was recorded. The accurate measurement of cup weight was not deemed practical or reliable; shell animals and fungi were found growing on some of the cup samples containing the photoaccelerant, affecting their respective weights.

The rate of photodegradation of the cups in these studies, as measured by the loss of cup weight or the cup disappearance rate, was the quickest when there were most extreme weather conditions, removing the tan surface layer. This surface layer corresponded to degraded polystyrene formed during photodegradation and, possibly, some minimal concentration of the photoaccelerant. For example, weathering in seawater resulted in the complete degradation of the photoaccelerant containing cups in eight months. In contrast, there was no physical change in the standard control cups for the length of this nine-month study.

In the same Southeastern locale, 18 months was required to completely degrade all of the same benzophenone-containing cups inverted, hanging from wooden pegs. While after 24 months, all of the control cups remained, although there was minimal weight loss of these cups at that time. Similar results were obtained for the other two on-land weathering studies in the Southwest and the Northeast U.S. All photodegradable cups were completely degraded after 11 and 12 months of exposure, respectively. The control cups remained physically unchanged over those respective time intervals.

Based on controlled laboratory results, demonstrating decreased degradation times from the constant UV exposure of cups with increasing benzophenone concentrations, dramatically shortened degradation times can be obtained in the environment when this photoaccelerant concentration is elevated above 2 wt % used in the above field studies. It should be possible to shorten the degradation time for litter to three or four weeks, or even less time.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A method of producing photodegradable, expandable polystyrene beads, comprising:
impregnating uniformly-sized polystyrene beads under heat and pressure with a mixture of a blowing agent and a photoaccelerant, and the photoaccelerant having been dissolved in the blowing agent prior to impregnation, to form a foamed polystyrene that includes about 0.5 to about 15 parts by weight of a photoaccelerant to about 100 parts by weight of the foamed polystyrene.

2. The method of claim 1, wherein the photoaccelerant is benzophenone.

3. The method of claim 1, wherein the impregnating step takes place at about 80° C. to about 150° C. and at a pressure of about 125 psig.

4. A foamed polystyrene article, comprising:
polystyrene beads having been impregnated, under heat and pressure, with a mixture of a blowing agent and a photoaccelerant and formed into predetermined geometric configurations using heat and steam to expand and fuse the beads in a mold resulting in a foamed polystyrene formed into a beverage or food container; and
wherein the blowing agent is cyclopentane.

5. The foamed polystyrene article of claim 4, wherein the beads are formed into packaging peanuts.

6. The foamed polystyrene article of claim 4 further comprising, feeding the polystyrene beads, impregnated with the blowing agent and photoaccelerant, into a heated extruder to form polystyrene sheets from which food and drink containers are made.

7. The foamed polystyrene article of claim 4 wherein the article is a food container.

8. The foamed polystyrene article of claim 4 wherein the article is a beverage container, a bowl, a platter, a plate or a claim shell container.

9. A litter abatement method comprising:
impregnating uniformly-sized polystyrene beads under heat and pressure with a mixture of a blowing agent and a photoaccelerant having been dissolved in the blowing agent prior to impregnation to form a foamed polystyrene that has about 0.5 to about 15 parts by weight of the photoaccelerant to about 100 parts by weight of a photodegradable foamed polystyrene article.

10. The litter abatement method of claim 9, wherein the blowing agent is present in the foamed polystyrene at about 3% to about 20% by weight.

11. The litter abatement method of claim 9 further comprising forming the heated impregnated polystyrene beads into a cup, a bowl, a platter, a plate or a clam shell container.

12. The litter abatement method of claim 9 further comprising forming the polystyrene beads into packaging peanuts.

13. A method of producing photodegradable expandable polystyrene beads, comprising:
impregnating polystyrene beads, under heat and pressure, with a mixture of a blowing agent and a photoaccelerant, wherein the photoaccelerant is dissolved in the blowing agent prior to impregnation, to form a foamed polystyrene that contains about 3% to about 20% by weight of a blowing agent and about 0.5% to about 15% by weight of a photoaccelerant.

14. The method of claim 13, wherein the photoaccelerant is benzophenone.

15. The method of claim 13, wherein the blowing agent is an alkane.

16. The method of claim 13, wherein the step of impregnating the polystyrene beads takes place at about 80° C. to about 150° C. and at a pressure of about 125 psig.

17. The method of claim 13, further comprising feeding the foamed polystyrene, impregnated with the blowing agent and photoaccelerant, into a heated extruder to form a photodegradable polystyrene sheet.

18. The method of claim 1, wherein the photoaccelerant is present in the foamed polystyrene in an amount that exceeds 3 parts by weight and up to 15 parts by weight relative to 100 parts by weight of the foamed polystyrene.
